(19) United States
(12) Patent Application Publication
(10) Pub. No.: US 2023/0159805 A1
(43) Pub. Date: May 25, 2023

(54) USE OF SILICONE TO FILL JOINTS

(71) Applicants: Jörg NASS, Goch (DE); Murat GÜNDÜZ, Gelsenkirchen (DE)

(72) Inventors: Joerg NASS, Goch (DE); Murat GUENDUEZ, Gelsenkirchen (DE)

(21) Appl. No.: 17/916,865

(22) PCT Filed: Jul. 9, 2021
(86) PCT No.: PCT/EP2021/069094

§ 371 Date: Oct. 4, 2022

(30) Foreign Application Priority Data
Jul. 15, 2020 (DE) 10 2020 118 742.4

(51) Int. Cl. C09K 3/10; C01G 9/02

(52) U.S. Cl. CPC C09K 3/10; C01G 9/02; C01P 2002/90; C09K 2200/0239; C09K 2200/0494

(57) ABSTRACT

When silicone is used to fill joints in surfaces on which vehicles drive, it is advantageous if the silicone contains zinc oxide in the form of tetrapod-shaped crystals.

### CROSS REFERENCE TO RELATED APPLICATIONS

This application is the National Stage of PCT/EP2021/069094 filed on Jul. 9, 2021, which claims priority under 35 U.S.C. §119 of German Application No. 10 2020 118 742.4 filed on Jul. 15, 2020, the disclosure of which is incorporated by reference. The international application under PCT article 21(2) was not published in English.

### BACKGROUND OF THE INVENTION

### 1. Field of the Invention

The invention relates to the use of silicone for filling of joints in surfaces over which vehicles travel.

### 2. Description of the Related Art

Silicones are heat-resistant, hydrophobic, dielectric and usually regarded as physiologically safe (not harmful to health), which is why they are used for skin protection, cosmetic skin care and plastic surgery. Physical analysis techniques, such as IR spectroscopy and pyrolysis gas chromatography, can be used for detection of silicones. The molecular weight distribution can be investigated by means of gel permeation chromatography.

In the past, liquid silicones have been used in cosmetics for injection under wrinkles. This technique is now uncommon, since the material tends to migration, whereupon granulomas (small growths that are non-cancerous but still troubling) are formed at places other than the injection site.

Silicone bags filled with silicone gel are used for silicone breast implants. However, it is not only for silicone breasts that the material is used in humans. Artificial heart valves, cardiac pacemakers, penile implants, skin creams, lubricants for syringes, etc. are also made from silicone. Compared with carbon-based plastics, silicones have the great advantage that the human immune system hardly reacts to them.

In dental medicine, silicones cross-linked by addition and condensation reactions are indispensable for taking exact impressions of the dental arches and of the jaws, in order to be able to make precision models.

In the plastination, silicone resins are used for impregnation of decomposable biological preparations.

In synthetic casting, silicone is used to make a negative mold for the subsequent casting of sculptures and reliefs. In this context, silicone is characterized by the accuracy of copying of surface details, and is practically shrinkage free during setting of the cast mold.

Perhaps the best-known use is in the building industry as a sealant for filling of joints. However, they are also used there for the production of impression and potting compounds and as coating compounds for fabrics. Bulkheads of silicone are used for sealing openings and joints in walls and ceilings that must have a fire rating. Here, the silicone serves not only as a seal but also as a component of a building part.

Molding silicones, building silicones, cosmetic silicones, etc. contain a multiplicity of fillers and additives. These improve their specific properties, depending on desired modification.

An entire series of building-related applications demands a highest degree of strength and tensile force as well as insensitivity to mechanical loads.

### PRIOR ART

The use of zinc oxide, which exists in the form of tetrapod-shaped crystals, is described, for example, in EP 2 782 103 A1, albeit for lacquered wire, and in DE 10 2013 104 195 A1 for optoelectronic devices.

The nano zinc oxide tetrapods (ZnO) are crystals of zinc oxide with a size of several nanometers to a few micrometers, i.e. a few thousandths to millionths millimeters small. They have the shape of tetrapods, four rigid arms that extend from a central point. Larger tetrapods of several meters are known as wave breakers for coastal protection of Sylt or Helgoland, where the arms interlock with one another and do so despite the forces of marine currents.

The arms of the tetrapods interlock with one another in the manner of staples and thus form a firm bond.

Nano zinc oxide tetrapods are needle-shaped crystals, produced from zinc metal vapor and oxygen. In the process, they grow in the direction of the C-axis of the respective hexagonal crystals of the zinc oxide from all of the four oppositely disposed surfaces of an octahedron. The crystal finds use in filters with very good filtering and dust-collecting properties on the basis of its shape, good photocatalyst activation on the basis of its semiconductor and UV-light-absorbing properties, and also as antibacterial material (zinc ion effect).

Properties:
Material name: zinc oxide
Chemical formula: ZnO
Molecular structure: single crystal (acicular)
Shape: tetrapod-shaped (four feet)
Average length of a foot: 10 µm to 20 µm
Specific weight: 5.78
Relative density: approx. 0.1
Melting point under pressure: 2,000° C.
Specific heat: 0.1248 cal/g * degree
Thermal conductivity: 25.3 W/m * K
Thermal expansion coefficient: 3.18x 10⁻⁶ rC
Reflectance index: 1.9 - 2.0
Electrical conductivity (2.4x 10¹⁰ Hz): ε = 8.5
Volume resistance: approx. 10 Ω * cm

The arms of the tetrapod staples interlock with one another and thus form a firm bond.

From US 2011 / 0 315 914 A1, a nanocomposite with high dielectric coefficient is known that consists of at least one ferroelectric filler and one non-ferroelectric filler, which are dispersed in a binder. The binder may consist of silicone. The non-ferroelectric filler may consist of nano zinc oxide tetrapods. A possible use as coating material for draining off static electricity is indicated.

From DE 10 2015 203 914 A1, elastomeric articles are known that consist of a rubber matrix, a component part and an adhesive system that joins these two and contains a primer. Heretofore, the joining of the parts has been achieved more by chemical reactions than by interlocking relationship.

If nano zinc tetrapods are used as primer, an interlocking relationship and thus also a better adhesion is achieved.

The elastomeric article known from DE 10 2015 203 914 A1 consists of a rubber matrix and a component part that are joined via a primer layer. The primer layer contains nano zinc oxide tetrapods. Indirectly, it is indicated that silicone and Teflon may also be joined with one another by nano zinc oxide tetrapods.

In summary, a component part is vulcanized here in or on a rubber matrix, by providing the component part with an adhesive layer that contains nano zinc oxide tetrapods and is then joined with the rubber matrix by vulcanization. The component part, the rubber matrix and the adhesive layer together form the elastomeric article.

Nano zinc oxide tetrapods and methyl vinyl silicone rubber are used in CN 106977824 A as optional components for a heat-resistant and age-resistant rubber seal for plate heat exchangers.

A windshield wiper blade cited in CN 108944810 A consists of, among other parts, a “scraping part”, which may contain, among other components, nano zinc oxide tetrapods and/or a silicone rubber composition.

### SUMMARY OF THE INVENTION

Task of the invention: The strength, especially the notch strength, and the tensile force of the silicone as well as its insensitivity to mechanical loads, are to be improved.

According to the invention, this task is accomplished during use of silicone for filling of joints in surfaces over which vehicles travel by the fact that the silicone contains zinc oxide that exists in the form of tetrapod-shaped crystals.

The nanocomposite from US 2011 / 0 315 914 A1 is not used specifically for joints.

The elastomeric article from DE 10 2015 203 914 A1 does not explicitly contain nano zinc oxide tetrapods as additives to silicone. In particular, a use of a mixture of silicone with nano zinc oxide tetrapods for filling of joints is not mentioned.

In CN 106977824 A also, a use of a mixture of silicone with nano zinc oxide tetrapods for filling of joints is not cited.

In CN 108944810 A, likewise no use of a silicone-nano zinc oxide tetrapods mixture for filling of joints is mentioned.

The use according to the invention of the silicone-nano zinc oxide tetrapods mixture for filling of joints was not obvious for a person skilled in the art, even having knowledge of the above-referenced publications. This is so because the use according to the invention for filling of joints in surfaces over which vehicles travel requires an increased notch strength of the joint compound, to which reference was not made in the publications as a special property of the mixture of silicone with nano zinc oxide tetrapods.

The person skilled in the art therefore had no reason to test the suitability of a mixture of silicone with nano zinc oxide tetrapods for the use for filling of joints in surfaces over which vehicles travel.

### ADVANTAGES OF THE INVENTION

The following advantages among others are achieved:

Additives are used in order to achieve a positive effect on manufacturing, storage, processing or product properties during and after the usage phase. In contrast to fillers, additives usually contribute only a few per cent to the total volume and are very finely distributed in the material.

As examples, additives ensure gloss effects, various viscosities, greater movement absorption, improved adherence, etc. Due to the introduction of nano zinc oxide tetrapods in silicone or sealants such as polyurethane sealants, sealants on the basis of silane-modified polymers, butyl sealants, acrylate sealants, etc., especially a higher tearing force and a better notch strength are achieved.

The additive according to the invention, namely zinc oxide, which exists in the form of tetrapod-shaped crystals, creates a tearing and tensile force as much as 70% greater in comparison with silicone sealants without this additive.

The percentage weight proportions in the manufacture of silicone mixtures (sealants) lie under one per cent. This is very dependent on the desired adjustment of the sealant material.

Further advantages:
Precise casting stability (castings)
Permanent pressure resistance (O-rings)
Abrasion resistance (ball bearings, toothed gears)
Micro reinforcement (adhesives)
Filters
Antialgal and antibacterial properties (color, synthetic resin, water)

Advantageous configurations of the invention are listed in the dependent claims.

### TEST AND COMPARISON EXAMPLES

Nano zinc oxide tetrapods of the Tianjin YR Chemspec Co., Ltd. were used in the following exemplary embodiments and test series.

The following were used
180 mm x 18 mm x 2 mm silicone strips without additive
180 mm x 18 mm x 6 mm silicone strips without additive
180 mm x 18 mm x 2 mm silicone strips with additive
180 mm x 18 mm x 6 mm silicone strips with additive
Tensile elongation of the silicone strips without and with additive: 300 mm
Behavior of the test strip (180 mm x 18 mm) containing different proportions of the additive:

Tensile force in Newtons

| Material thickness in mm | Proportion of additive in wt-% | | | | | | |
|---|---|---|---|---|---|---|---|
| | 0 | 0.5 | 1 | 2 | 3 | 4 | 5 |
| 2 | 0.80 N | 0.84 N | 0.88 N | 0.97 N | 1.07 N | 1.17 N | 1.29 N |
| 6 | 2.40 N | 2.52 N | 2.64 N | 2.90 N | 3.19 N | 3.51 N | 3.87 N |

### EXAMPLES OF APPLICATION

The nano zinc oxide tetrapod possesses a higher body stability, which creates advantages, especially at smaller layer thickness.

Examples of advantages are insensitivity to mechanical influences, less abrasion.

Silicone containing nano zinc oxide tetrapods may be used as sealant at particularly exposed places (underground garage entrances, heavily traveled regions). Examples of advantages are insensitivity to mechanical influences, less abrasion.

A further advantage is the antibacterial property, which makes the use in hospitals or commercial kitchens possible.

Due to the antibacterial property of the zinc oxide tetrapods, a mold resistance of the silicone is achieved.

Further advantages are that a high UV stability and a that better resistance to shearing forces are achieved due to the addition of the zinc oxide tetrapods.

Furthermore, the silicone provided with the additive according to the invention is characterized by a high notch strength, which is important in particular during the application to joints with a high mechanical load and/or a high cleaning intensity.

1. A method for filling of joints in surfaces over which vehicles travel, comprising filling the joints with silicone, wherein the silicone contains zinc oxide that exists in the form of tetrapod-shaped crystals.

2. The method according to claim 1, wherein the silicone contains at most 5 wt% of zinc oxide.

3. The method according to claim 1, wherein the silicone contains at least 0.5 wt% of zinc oxide.
